(19) United States
(12) Patent Application Publication
(10) Pub. No.: US 2008/0281445 A1
(43) Pub. Date: Nov. 13, 2008

(54) TALK ABOUT IT

(76) Inventor: Lewis S. Sims Angel, Chicago, IL (US)

Correspondence Address: LEWIS S. SIMS, 709 S. KENNETH, CHICAGO, IL, 60624, US

(21) Appl. No.: 11/745,204

(22) Filed: May 7, 2007

(51) Int. Cl. G06F 17/00; H04B 1/00

(52) U.S. Cl. 700/94; 381/86

(57) ABSTRACT

This device is built on many features. It relates to an Mp3-player which gives it the capability to be used with your car stereo system. In short, you will have the ability to use your Mp3-player with the use of your car stereo.

You will also have the ability to install and use this invention without the need for attachments such as USB cords.

This device will also enable you to download music from your PC or directly from your car stereo.

You will be able to play DVD's as well as CD's that have been ripped or burned from your PC or car Stereo.

It will include broadband radio (AM&FM) DVD player, high speed copier, bass and treble tuner, clock and timer.

### CROSS REFERENCE TO RELATED APPLICATIONS

None at this time

### FEDERALLY SPONSORED RESEARCH

None at this time

### SEQUENCE LISTINGS

None at this time

This invention relates to an Mp3-player and the ability to use your Mp3-player within the use of your car radio, with portable qualities of not needing various attachments. This invention has the capabilities of an IPOD in regards to downloading and storing CD contents which solves a common inconvenience of misplaced CD's.

My invention downloads, stores, as well as plays music from a variety of sources including but not limited to broadband stations (AM, FM) with CD player capability.

### BACKGROUND

This invention by me, Lewis S. Sims will give you the benefit of not needing to use earplugs, headphones or attachments of the like while being used with your car stereo system. These attachments from any device(s) you will have in the base of the stereo that holds all data and functions. Some may say this invention is built upon many features.

### MAKING OF THE DESIGN

It is done by taking two motherboards with two different designs which are today in high demand, connecting these two designs together to make one motherboard as one program.

### The Front of Design

The front of this Mp3 Face-Off Car Radio should have style and class when considering design.

My vision is to have the screen of an Mp3 player on the face of my device to be available in an assortment of colors. The display screen will show how to work all functions on the Mp3 Face-Off Car Radio. I believe my invention will function better than any other car stereo on the market today. My invention will be the only stereo system that will be able to download and play CD's, play DVD's as well as give the basic function of a car stereo.

### CD Player

The CD player on my invention will operate as such; put the CD or DVD of your choice into the base of the component and the Mp3 will download to the memory of the base.

The memory of the invention has 4 mgh. It will work just like an Mp3 player. You can download from home, car, or computer.

The Mp3 Face-Off Car Radio is built with a face-off attachment which will have a sub cord (or USB) made to fit the system. It can be plugged into the side of the face-off by removing the face-off radio and taking the face-off and sub cord to local and available PC attaching the sub cord into the side of this device and a PC. You can take the USB cord and plug it into the computer and download other music and movies.

First came the 8 track, then the cassette player, the CD player followed which was an improved design of the walk-man. When the Mp3 player came on the scene, who would have thought further than that? I have! The Mp3-Face-Off Radio is the next best thing that is to come. Don't miss out, open your mind and explore the endless possibilities of my invention. It's the next step to modernize the ever changing technology of car stereo systems. I pray that you will review and accept my new invention with the enthusiasm that I possess and the faith that it will far exceed all my expectations.

1. A detachable device for your vehicle that rips burns and plays downloaded music from the comfort of your vehicle.

2. This device possesses the portable qualities of not needing to use attachments such as USB cords, earplugs or headphones.

3. An emphasis is placed on the ability to install this device without use of a USB cord which is usually needed to enable such a device to be used with a car stereo system.

4. Because my device will be built into to face of the car stereo that holds the “face-off” attachment together as one component, the “face-off” component can be used on a home computer for downloads. It is the base where all the data is kept not the face of the component which makes this feature possible.

5. Navigation System

6. Satellite Radio

7. Bluetooth

8. Flip Screen (7″)

9. Radio Tuner

10. Records Music from Tuner

11. Touch Screen manual and remote control access.
